(19) United States
(12) Patent Application Publication
(10) Pub. No.: US 2024/0284238 A1
(43) Pub. Date: Aug. 22, 2024

(54) SYSTEMS, METHODS, AND DEVICES FOR PACKET DATA CONVERGENCE PROTOCOL (PDCP) OUT-OF-ORDER DELIVERY

(71) Applicant: Apple Inc., Cupertino, CA (US)

(72) Inventors: Ralf Rossbach, Munich (DE); Bobby Jose, San Diego, CA (US); Vijay Venkataraman, San Jose, CA (US); Fangli Xu, Beijing (CN); Ping-Heng Kuo, London (GB); Haijing Hu, Los Gatos, CA (US)

(21) Appl. No.: 18/414,951

(22) Filed: Jan. 17, 2024

Related U.S. Application Data
(60) Provisional application No. 63/485,457, filed on Feb. 16, 2023.

(51) Int. Cl. H04W 28/02

(52) U.S. Cl. CPC H04W 28/0252; H04W 28/0268

(57) ABSTRACT

The techniques described herein may include a device, comprising: a memory; and one or more processors configured to, when executing instructions stored in the memory, cause the device to: communicate, via a wireless communication network, information as in-order traffic; and communicate, via the wireless communication network, information using out-of-order traffic. The out-of-order traffic may comprise selective out-of-order delivery OOD or per-packet OOD delivery. Additional examples, features and other techniques are also described herein.

### REFERENCE TO RELATED APPLICATIONS

This application claims the benefit of U.S. Provisional Application No. 63/485,457, filed on Feb. 16, 2023, the contents of which are hereby incorporated by reference in their entirety.

### FIELD

This disclosure relates to wireless communication networks and mobile device capabilities.

### BACKGROUND

Wireless communication networks and wireless communication services are becoming increasingly dynamic, complex, and ubiquitous. For example, some wireless communication networks may be developed to implement fifth generation (5G) or new radio (NR) technology, sixth generation (6G) technology, and so on. Such technology may include solutions for enabling user equipment (UE) and network devices, such as base stations, to communicate with one another.

### BRIEF DESCRIPTION OF THE DRAWINGS

The present disclosure will be readily understood and enabled by the detailed description and accompanying figures of the drawings. Like reference numerals may designate like features and structural elements. Figures and corresponding descriptions are provided as non-limiting examples of aspects, implementations, etc., of the present disclosure, and references to “an” or “one” aspect, implementation, etc., may not necessarily refer to the same aspect, implementation, etc., and may mean at least one, one or more, etc.

FIG. 1 is a diagram of an example network according to one or more implementations described herein.

FIG. 2 is a diagram of an example of a network 200 according to one or more implementations described herein.

FIG. 3 is a diagram of an example of user plane protocol stacks 300 in accordance with one or more implementations described herein.

FIG. 4 is a diagram of an example process 400 for out-of-order delivery (OOD) according to one or more implementations described herein.

FIGS. 5-6 are diagrams of examples of a user plane stack of a transmitter 500 and corresponding user plane stack of a receiver 600 according to one or more implementations described herein.

FIGS. 7-8 are diagrams of examples of a user plane stack of a transmitter 700 and corresponding user plane stack of a receiver according to one or more implementations described herein.

FIGS. 9-11 are diagrams of example information elements (IEs) of QoS flow characteristics according to one or more implementations described herein.

FIG. 12 is a diagram of an example of components of a device according to one or more implementations described herein.

FIG. 13 is a block diagram illustrating components, according to one or more implementations described herein, able to read instructions from a machine-readable or computer-readable medium (e.g., a non-transitory machine-readable storage medium) and perform any one or more of the methodologies discussed herein.

FIG. 14 is a diagram of an example of devices, layers, and interfaces according to one or more implementations described herein.

FIG. 15 is a diagram of an end-to-end example implementation of selective OOD according to one or more implementations described herein.

FIG. 16 is a diagram of an example of PDU sets sent and received using a packet data unit (PDU) set descriptor and/or a PDU set header according to one or more implementations described herein.

### DETAILED DESCRIPTION

The following detailed description refers to the accompanying drawings. Like reference numbers in different drawings may identify the same or similar features, elements, operations, etc. Additionally, the present disclosure is not limited to the following description as other implementations may be utilized, and structural or logical changes made, without departing from the scope of the present disclosure.

Telecommunication networks may include user equipment (UEs) capable of communicating with base stations and/or other network access nodes. UEs and base stations may implement various techniques and communications standards for enabling UEs and base stations to discover one another, establish and maintain connectivity, and exchange information in an ongoing manner. Objectives of such techniques may include connection reliability, seamless connectivity between devices, multiple points of connection, quality of service and throughput rates, and more. Aspect of telecommunication that relates to how devices communicate with each other include data radio bearers (DRBs) and packet data convergence protocol (PDCP).

For a given data radio bearer (DRB) the new radio (NR) PDCP layer may support reordering and in-order delivery of service data units (SDUs) as a default or mandatory configuration. The functionality of this feature may entail a PDCP receiver ensuring that packets are delivered to upper layers in-sequence (according to a PDCP sequence number (SN)). A reordering function may be used to provide in-sequence delivery of SDUs, which may involve a temporary buffering of SDUs received out-of-sequence, as well as the operation of a reordering timer. Additionally, reordering may be based on sequence numbers (COUNT) deducted/received from every PDCP packet (hyper frame number (HFN), SN) and a reordering timer configured by RRC. Thus, the reordering function may not only require memory for intermediate storage, but it may also increase an overall end-to-end latency and cause delay variance. RRC can optionally configure a DRB to operate without strict in-sequence delivery. In such a scenario, the PDCP receiver may deliver PDCP SDUs to upper layers immediately (e.g., in the order received), and depending on the reception order, this may result in packets being delivered out of sequence. This function may be referred to as “out-of-order delivery,” and it may be enabled for the Uu interface or the sidelink (SL) interface. The example on the right applies to the Uu interface.

Configuring devices for out-of-order delivery (OOD) may be beneficial for DRBs that carry traffic where reordering is provided at higher layers. Examples of such benefits may include latency reduction for end-to-end services, a reduction in memory or buffer usage, and so on. Situations where OOD may be beneficial may include low latency and ultra-reliable low latency communication (URLLC) scenarios, preferably via separate beams. Examples of such situations may include a real-time protocol (RTP), such as video streaming, because of the low latency requirements, real-time audio streaming since reordering may be performed in the application jitter buffer, and so on. Stream control transmission protocol (SCTP) may be used to ensure that message are delivered in-sequence within a given stream. If multiple streams are used in an SCTP scenario, reordering at PDCP may result in longer delays for application streams using SCTP. SCTP provides a mechanism for bypassing the in-sequence delivery service. For example, user messages sent using this mechanism may be delivered to the SCTP user as soon as they are received.

In-order or in-sequence delivery (as well as PDCP reordering) may be beneficial to transmission control protocol (TCP) scenarios. Newer versions of the TCP protocol may handle out-of-sequence reception of packets more gracefully compared to older TCP protocol versions. Robust header compression (RoHC) and uplink data compression (UDC) may only be processed in-sequence, so if there are PDCP out-of-sequence packets that become in-sequence, the packet may be fed back to a RoHC engine or UDC engine. As such, OOD is not supported when RoHC or UDC are configured, and both functions may only be configured per DRB.

Accordingly, to obtain a latency benefit for packets that do not have a strict in-sequence delivery requirement, an out-of-order delivery mechanism may be selected for a separate DRB for the packets. However, currently multiple quality of service (QOS) flows (e.g., multiple traffic flows or service data flows (SDFs) may often be carried on the same DRB. With extended reality (XR) and the advent of PDU Sets, the amount and variety of Internet protocol (IP) traffic flows, SDFs, and QoS flows coming into PDCP is increasing. Spreading those flows out over separate DRBs may increase the overall number of DRBs that are used concurrently between systems and devices. System provisioning and/or dimensioning of resources for a higher number of DRBs may involve more processing (e.g., central processing unit (CPU)) and memory resources for UEs and base stations, and an overall increase in power consumption. System and device operations that ensure a limited number of DRBs is desirable.

3rd generation partnership (3GPP) out-of-order delivery (OOD) may enable OOD for all packets received on a configured DRB. In other words, the current PDCP protocol does not allow a DRB to deliver some packets out-of-order and other packets in-order. The OOD configuration (e.g., RRC parameter outOfOrderDelivery and sl-outOfOrderDelivery) applies to all QOS flows mapped to the DRB, including all types of layer 3 (L3) and layer 4 (L4) packets, TCP data, and TCP acknowledgement (ACK) packets.

Application traffic flows that do not require in-order delivery are often mapped to the same DRB together with other traffic flows that require strict in-order delivery. This consumes more processing resources than needed. Moreover, even for a single L3/L4 flow or application layer traffic with strict in-order delivery, sometimes part of the traffic may result in performance improvements when certain packets are delivered out-of-order (e.g., cumulative TCP ACK.). UE implementations where access stratum (AS) layers are tightly coupled with applications on internal interfaces and UEs that deploy deep packet inspection techniques on L3/L4 are well suited to identify packets within a flow that can benefit from out of sequence delivery on the uplink (UL).

Techniques, described herein, may enable a wireless communication network to implement in-order and OOD in a more efficient and effect manner. End devices, such as a user equipment (UE), base station, and core network functions may implement selective OOD or per-packet ODD. In some implementations, OOD traffic (e.g., PDUs, SDUs, QoS flows, etc.) may be associated with a DRB, quality flow identifier (QFI), a packet header flag, or payload indications used to differentiate the OOD traffic from in-order traffic. Generally, OOD may include an ability of a PDCP layer of UE 110 to immediately relay (or deliver, after completion of PDCP processing) received data units (PDUs, SDUs, etc.) to higher layers of UE 110 (e.g., regardless of whether the data units are received by the PDCP layer in-order. In such a scenario, the data units may be reordered by one of the higher layers of UE 110. Selective OOD may include OOD that may apply to traffic in a QoS flow, PDU set, PDU set type, PDU session, RTP session, traffic flow or SDF. Per-packet OOD may include an ability of a PDCP layer of UE 110 to immediately relay received information on a per-packet basis. For example, UE 110 may determine whether a header field of a received packet indicates that the packet is designated for OOD and process the packet accordingly. In some implementations, selective OOD may refer to a combined OOD mode applicable to both per-packet and per-flow traffic, and may be controlled by a single parameter. These and other features and capabilities are enabled by one or more of the techniques described herein.

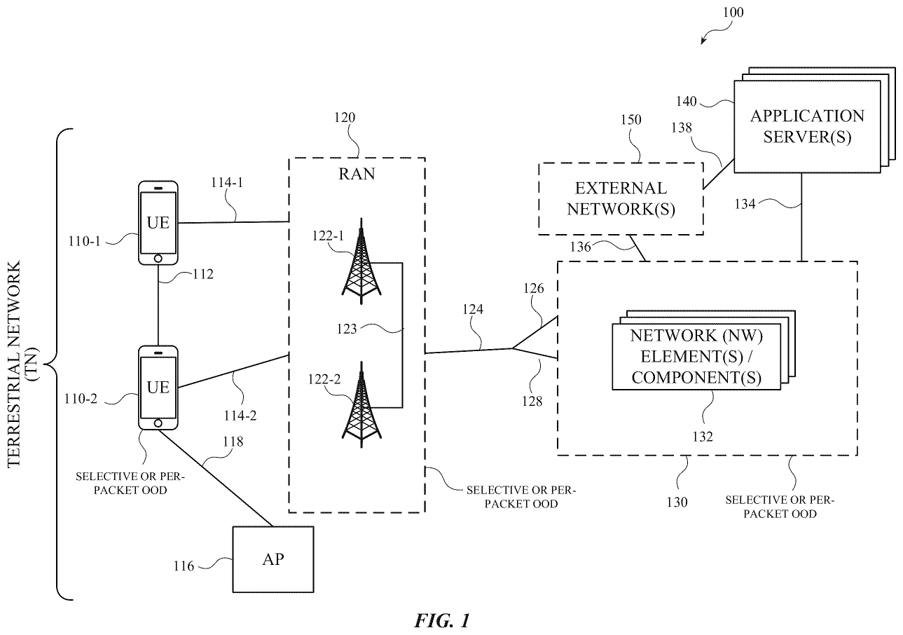

FIG. 1 is an example network 100 according to one or more implementations described herein. Example network 100 may include UEs 110-1, 110-2, etc. (referred to collectively as “UEs 110” and individually as “UE 110”), a radio access network (RAN) 120, a core network (CN) 130, application servers 140, and external networks 150.

The systems and devices of example network 100 may operate in accordance with one or more communication standards, such as 1nd generation (2G), 3rd generation (3G), 4th generation (4G) (e.g., long-term evolution (LTE)), and/or 5th generation (5G) (e.g., new radio (NR)) communication standards of the 3rd generation partnership project (3GPP). Additionally, or alternatively, one or more of the systems and devices of example network 100 may operate in accordance with other communication standards and protocols discussed herein, including future versions or generations of 3GPP standards (e.g., sixth generation (6G) standards, seventh generation (7G) standards, etc.), institute of electrical and electronics engineers (IEEE) standards (e.g., wireless metropolitan area network (WMAN), worldwide interoperability for microwave access (WiMAX), etc.), and more.

As shown, UEs 110 may include smartphones (e.g., handheld touchscreen mobile computing devices connectable to one or more wireless communication networks). Additionally, or alternatively, UEs 110 may include other types of mobile or non-mobile computing devices capable of wireless communications, such as personal data assistants (PDAs), pagers, laptop computers, desktop computers, wireless handsets, etc. In some implementations, UEs 110 may include internet of things (IoT) devices (or IoT UEs) that may comprise a network access layer designed for low-power IoT applications utilizing short-lived UE connections. Additionally, or alternatively, an IoT UE may utilize one or more types of technologies, such as machine-to-machine (M2M) communications or machine-type communications (MTC) (e.g., to exchanging data with an MTC server or other device via a public land mobile network (PLMN)), proximity-based service (ProSe) or device-to-device (D2D) communications, sensor networks, IoT networks, and more. Depending on the scenario, an M2M or MTC exchange of data may be a machine-initiated exchange, and an IoT network may include interconnecting IoT UEs (which may include uniquely identifiable embedded computing devices within an Internet infrastructure) with short-lived connections. In some scenarios, IoT UEs may execute background applications (e.g., keep-alive messages, status updates, etc.) to facilitate the connections of the IoT network.

UEs 110 may communicate and establish a connection with one or more other UEs 110 via one or more wireless channels 112, each of which may comprise a physical communications interface/layer. The connection may include an M2M connection, MTC connection, D2D connection, SL connection, etc. The connection may involve a PC5 interface. In some implementations, UEs 110 may be configured to discover one another, negotiate wireless resources between one another, and establish connections between one another, without intervention or communications involving RAN node 122 or another type of network node. In some implementations, discovery, authentication, resource negotiation, registration, etc., may involve communications with RAN node 122 or another type of network node.

UEs 110 may use one or more wireless channels 112 to communicate with one another. As described herein, UE 110-1 may communicate with RAN node 122 to request SL resources. RAN node 122 may respond to the request by providing UE 110 with a dynamic grant (DG) or configured grant (CG) regarding SL resources. A DG may involve a grant based on a grant request from UE 110. A CG may involve a resource grant without a grant request and may be based on a type of service being provided (e.g., services that have strict timing or latency requirements). UE 110 may perform a clear channel assessment (CCA) procedure based on the DG or CG, select SL resources based on the CCA procedure and the DG or CG; and communicate with another UE 110 based on the SL resources. The UE 110 may communicate with RAN node 122 using a licensed frequency band and communicate with the other UE 110 using an unlicensed frequency band.

UEs 110 may communicate and establish a connection with (e.g., be communicatively coupled) with RAN 120, which may involve one or more wireless channels 114-1 and 114-2, each of which may comprise a physical communications interface/layer. In some implementations, a UE may be configured with dual connectivity (DC) as a multi-radio access technology (multi-RAT) or multi-radio dual connectivity (MR-DC), where a multiple receive and transmit (Rx/Tx) capable UE may use resources provided by different network nodes (e.g., 122-1 and 122-2) that may be connected via non-ideal backhaul (e.g., where one network node provides NR access and the other network node provides either E-UTRA for LTE or NR access for 5G). In such a scenario, one network node may operate as a master node (MN) and the other as the secondary node (SN). The MN and SN may be connected via a network interface, and at least the MN may be connected to the CN 130. Additionally, at least one of the MN or the SN may be operated with shared spectrum channel access, and functions specified for UE 110 can be used for an integrated access and backhaul mobile termination (IAB-MT). Similar for UE 110, the IAB-MT may access the network using either one network node or using two different nodes with enhanced dual connectivity (EN-DC) architectures, new radio dual connectivity (NR-DC) architectures, or the like. In some implementations, a base station (as described herein) may be an example of network node 122.

As described herein, UE 110 may receive and store one or more configurations, instructions, and/or other information for enabling SL-U communications with quality and priority standards. A PQI may be determined and used to indicate a QoS associated with an SL-U communication (e.g., a channel, data flow, etc.). Similarly, an L1 priority value may be determined and used to indicate a priority of an SL-U transmission, SL-U channel, SL-U data, etc. The PQI and/or L1 priority value may be mapped to a CAPC value, and the PQI, L1 priority, and/or CAPC may indicate SL channel occupancy time (COT) sharing, maximum (MCOT), timing gaps for COT sharing, LBT configuration, traffic and channel priorities, and more.

As shown, UE 110 may also, or alternatively, connect to access point (AP) 116 via connection interface 118, which may include an air interface enabling UE 110 to communicatively couple with AP 116. AP 116 may comprise a wireless local area network (WLAN), WLAN node, WLAN termination point, etc. The connection 116 may comprise a local wireless connection, such as a connection consistent with any IEEE 802.11 protocol, and AP 116 may comprise a wireless fidelity (Wi-Fi®) router or other AP. While not explicitly depicted in FIG. 1, AP 116 may be connected to another network (e.g., the Internet) without connecting to RAN 120 or CN 130. In some scenarios, UE 110, RAN 120, and AP 116 may be configured to utilize LTE-WLAN aggregation (LWA) techniques or LTE WLAN radio level integration with IPsec tunnel (LWIP) techniques. LWA may involve UE 110 in RRC_CONNECTED being configured by RAN 120 to utilize radio resources of LTE and WLAN. LWIP may involve UE 110 using WLAN radio resources (e.g., connection interface 118) via IPsec protocol tunneling to authenticate and encrypt packets (e.g., Internet Protocol (IP) packets) communicated via connection interface 118. IPsec tunneling may include encapsulating the entirety of original IP packets and adding a new packet header, thereby protecting the original header of the IP packets.

RAN 120 may include one or more RAN nodes 122-1 and 122-2 (referred to collectively as RAN nodes 122, and individually as RAN node 122) that enable channels 114-1 and 114-2 to be established between UEs 110 and RAN 120. RAN nodes 122 may include network access points configured to provide radio baseband functions for data and/or voice connectivity between users and the network based on one or more of the communication technologies described herein (e.g., 1G, 3G, 4G, 5G, WiFi®, etc.). As examples therefore, a RAN node may be an E-UTRAN Node B (e.g., an enhanced Node B, eNodeB, eNB, 4G base station, etc.), a next generation base station (e.g., a 5G base station, NR base station, next generation eNBs (gNB), etc.). RAN nodes 122 may include a roadside unit (RSU), a transmission reception point (TRxP or TRP), and one or more other types of ground stations (e.g., terrestrial access points). In some scenarios, RAN node 122 may be a dedicated physical device, such as a macrocell base station, and/or a low power (LP) base station for providing femtocells, picocells or the like having smaller coverage areas, smaller user capacity, or higher bandwidth compared to macrocells.

Some or all of RAN nodes 122, or portions thereof, may be implemented as one or more software entities running on server computers as part of a virtual network, which may be referred to as a centralized RAN (CRAN) and/or a virtual baseband unit pool (vBBUP). In these implementations, the CRAN or vBBUP may implement a RAN function split, such as a packet data convergence protocol (PDCP) split wherein radio resource control (RRC) and PDCP layers may be operated by the CRAN/vBBUP and other Layer 2 (L2) protocol entities may be operated by individual RAN nodes 122; a media access control (MAC)/physical (PHY) layer split wherein RRC, PDCP, radio link control (RLC), and MAC layers may be operated by the CRAN/vBBUP and the PHY layer may be operated by individual RAN nodes 122; or a “lower PHY” split wherein RRC, PDCP, RLC, MAC layers and upper portions of the PHY layer may be operated by the CRAN/vBBUP and lower portions of the PHY layer may be operated by individual RAN nodes 122. This virtualized framework may allow freed-up processor cores of RAN nodes 122 to perform or execute other virtualized applications.

In some implementations, an individual RAN node 122 may represent individual gNB-distributed units (DUs) connected to a gNB-control unit (CU) via individual F1 or other interfaces. In such implementations, the gNB-DUs may include one or more remote radio heads or radio frequency (RF) front end modules (RFEMs), and the gNB-CU may be operated by a server (not shown) located in RAN 120 or by a server pool (e.g., a group of servers configured to share resources) in a similar manner as the CRAN/vBBUP. Additionally, or alternatively, one or more of RAN nodes 122 may be next generation eNBs (i.e., gNBs) that may provide evolved universal terrestrial radio access (E-UTRA) user plane and control plane protocol terminations toward UEs 110, and that may be connected to a 5G core network (5GC) 130 via an NG interface.

Any of the RAN nodes 122 may terminate an air interface protocol and may be the first point of contact for UEs 110. In some implementations, any of the RAN nodes 122 may fulfill various logical functions for the RAN 120 including, but not limited to, radio network controller (RNC) functions such as radio bearer management, uplink and downlink dynamic radio resource management and data packet scheduling, and mobility management. UEs 110 may be configured to communicate using orthogonal frequency-division multiplexing (OFDM) communication signals with each other or with any of the RAN nodes 122 over a multicarrier communication channel in accordance with various communication techniques, such as, but not limited to, an OFDMA communication technique (e.g., for downlink communications) or a single carrier frequency-division multiple access (SC-FDMA) communication technique (e.g., for uplink and ProSe or sidelink (SL) communications), although the scope of such implementations may not be limited in this regard. The OFDM signals may comprise a plurality of orthogonal subcarriers.

In some implementations, a downlink resource grid may be used for downlink transmissions from any of the RAN nodes 122 to UEs 110, and uplink transmissions may utilize similar techniques. The grid may be a time-frequency grid (e.g., a resource grid or time-frequency resource grid) that represents the physical resource for downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises resource blocks, which describe the mapping of certain physical channels to resource elements. Each resource block may comprise a collection of resource elements (REs); in the frequency domain, this may represent the smallest quantity of resources that currently may be allocated. There are several different physical downlink channels that are conveyed using such resource blocks.

Further, RAN nodes 122 may be configured to wirelessly communicate with UEs 110, and/or one another, over a licensed medium (also referred to as the “licensed spectrum” and/or the “licensed band”), an unlicensed shared medium (also referred to as the “unlicensed spectrum” and/or the “unlicensed band”), or combination thereof. A licensed spectrum may correspond to channels or frequency bands selected, reserved, regulated, etc., for certain types of wireless activity (e.g., wireless telecommunication network activity), whereas an unlicensed spectrum may correspond to one or more frequency bands that are not restricted for certain types of wireless activity. Whether a particular frequency band corresponds to a licensed medium or an unlicensed medium may depend on one or more factors, such as frequency allocations determined by a public-sector organization (e.g., a government agency, regulatory body, etc.) or frequency allocations determined by a private-sector organization involved in developing wireless communication standards and protocols, etc.

To operate in the unlicensed spectrum, UEs 110 and the RAN nodes 122 may operate using stand-alone unlicensed operation, licensed assisted access (LAA), eLAA, and/or feLAA mechanisms. In these implementations, UEs 110 and the RAN nodes 122 may perform one or more known medium-sensing operations or carrier-sensing operations in order to determine whether one or more channels in the unlicensed spectrum is unavailable or otherwise occupied prior to transmitting in the unlicensed spectrum. The medium/carrier sensing operations may be performed according to a listen-before-talk (LBT) protocol.

The PDSCH may carry user data and higher layer signaling to UEs 110. The physical downlink control channel (PDCCH) may carry information about the transport format and resource allocations related to the PDSCH channel, among other things. The PDCCH may also inform UEs 110 about the transport format, resource allocation, and hybrid automatic repeat request (HARQ) information related to the uplink shared channel. Typically, downlink scheduling (e.g., assigning control and shared channel resource blocks to UE 110-2 within a cell) may be performed at any of the RAN nodes 122 based on channel quality information fed back from any of UEs 110. The downlink resource assignment information may be sent on the PDCCH used for (e.g., assigned to) each of UEs 110.

As described herein, UE 110, base station 122, and functions of CN 130 may communicate with one another using in-order traffic and out-of-order traffic. The out-of-order traffic may comprise selective out-of-order delivery OOD or per-packet OOD delivery. Traffic may include PDUs SDUs, QoS flows, and more. Selective OOD may include OOD that may apply to traffic in a QoS flow, PDU set, PDU set type, PDU session, RTP session, traffic flow or SDF. Per-packet OOD may include an ability of a PDCP layer of UE 110 to immediately relay received information on a per-packet basis. In-order traffic may be differentiated from out-of-order traffic based on the corresponding traffic flow, packet header flags, payload content, QoS rules, and more.

The RAN nodes 122 may be configured to communicate with one another via interface 123. In implementations where the system is an LTE system, interface 123 may be an X2 interface. In NR systems, interface 123 may be an Xn interface. The X2 interface may be defined between two or more RAN nodes 122 (e.g., two or more eNBs/gNBs or a combination thereof) that connect to evolved packet core (EPC) or CN 130, or between two eNBs connecting to an EPC. In some implementations, the X2 interface may include an X2 user plane interface (X2-U) and an X2 control plane interface (X2-C). The X2-U may provide flow control mechanisms for user data packets transferred over the X2 interface and may be used to communicate information about the delivery of user data between eNBs or gNBs. For example, the X2-U may provide specific sequence number information for user data transferred from a master eNB (MeNB) to a secondary eNB (SeNB); information about successful in sequence delivery of PDCP packet data units (PDUs) to a UE 110 from an SeNB for user data; information of PDCP PDUs that were not delivered to a UE 110; information about a current minimum desired buffer size at the SeNB for transmitting to the UE user data; and the like. The X2-C may provide intra-LTE access mobility functionality (e.g., including context transfers from source to target eNBs, user plane transport control, etc.), load management functionality, and inter-cell interference coordination functionality.

As shown, RAN 120 may be connected (e.g., communicatively coupled) to CN 130. CN 130 may comprise a plurality of network elements 132, which are configured to offer various data and telecommunications services to customers/subscribers (e.g., users of UEs 110) who are connected to the CN 130 via the RAN 120. In some implementations, CN 130 may include an evolved packet core (EPC), a 5G CN, and/or one or more additional or alternative types of CNs. The components of the CN 130 may be implemented in one physical node or separate physical nodes including components to read and execute instructions from a machine-readable or computer-readable medium (e.g., a non-transitory machine-readable storage medium). In some implementations, network function virtualization (NFV) may be utilized to virtualize any or all the above-described network node roles or functions via executable instructions stored in one or more computer-readable storage mediums (described in further detail below). A logical instantiation of the CN 130 may be referred to as a network slice, and a logical instantiation of a portion of the CN 130 may be referred to as a network sub-slice. Network Function Virtualization (NFV) architectures and infrastructures may be used to virtualize one or more network functions, alternatively performed by proprietary hardware, onto physical resources comprising a combination of industry-standard server hardware, storage hardware, or switches. In other words, NFV systems may be used to execute virtual or reconfigurable implementations of one or more EPC components/functions.

As shown, CN 130, application servers 140, and external networks 150 may be connected to one another via interfaces 134, 136, and 138, which may include IP network interfaces. Application servers 140 may include one or more server devices or network elements (e.g., virtual network functions (VNFs) offering applications that use IP bearer resources with CN 130 (e.g., universal mobile telecommunications system packet services (UMTS PS) domain, LTE PS data services, etc.). Application servers 140 may also, or alternatively, be configured to support one or more communication services (e.g., voice over IP (VOIP sessions, push-to-talk (PTT) sessions, group communication sessions, social networking services, etc.) for UEs 110 via the CN 130. Similarly, external networks 150 may include one or more of a variety of networks, including the Internet, thereby providing the mobile communication network and UEs 110 of the network access to a variety of additional services, information, interconnectivity, and other network features.

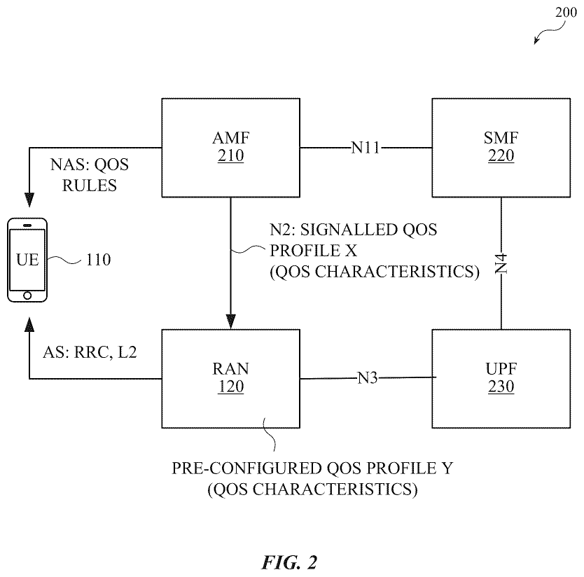

FIG. 2 is a diagram of an example of a network 200 according to one or more implementations described herein. As shown, network 200 may include UE 110, RAN 120, access and mobility management function (AMF) 210, session management function (SMF) 220), and user plane function (UPF) 230). AMF 210, SMF 220, and UPF 230 may be functions of CN 130 and may be implemented by one or more servers in a centralized or distributed networking environment.

AMF 210 may communicate with base station 122 via an N2 interface and UE 110 via an N1 interface. AMF 210 may manage authentication, registration, and other functionalities relating to UEs 110 accessing a telecommunication mobile network. AMF 210 may also handle handovers, paging, and other functionality regarding the mobility and communications of UEs 110. AMF 210 may also provide security functionality for authenticating and authorizing UEs 110. SMF 220 may communicate with AMF via an N11 interface and UPF 230 via an N4 interface.

SMF 220 may provide for session management, UE IP address allocation and management, and selection and control of UP functions. SMF 220 may also support traffic steering at UPF 230, control plane policy enforcement and QoS, and DL data notifications. UPF 230 may communicate with RAN 120 via an N3 interface and SMF 220 via an N4 interface. UPF 230 may operate as a point of connection for PDU sessions between RAN 120 and external data networks. UPF 230 may also provide support for packet routing, forwarding, and inspection. UPF 230 may further provide for user plane rule enforcement, QoS handling, UL/DL rate enforcement, and SDF to QoS flow mapping.

UE 110 may receive information from RAN 120 via an access stratum (AS) interface. The information may include RRC and L2 information. A QoS flow may also be configured from SMF 220 to RAN 120 and UE 110. Each QoS flow may be associated with a set of QoS characteristics that may be part of a QoS profile stored by RAN 120 and updated by AMF 210. Examples of QoS characteristics may include a resource type, packet delay budget (PDB), packet error rate (PER), averaging window, and more. AMF 210 may provide UE 110 with QoS rules during a PDU session via a non-access stratum (NAS) protocol or interface.

QOS rules may also, or alternatively, be pre-configured in UE 110 and/or implicitly derived by applying a reflective QoS. A QoS rule may include the quality flow identifier (QFI) of the associated QoS flow, a packet filter set, and a precedence value. For a dynamically assigned QFI, the QoS rule may include the QoS parameters relevant to UE 110 (e.g., standardized 5G quality identifiers (5QIs), guaranteed bit rate (GBR), a maximum bit rate (MBR), and an averaging window. A complete set QoS characteristics may not be transferred over the air interface, UE 110 may instead be provided with QoS rules. For specific parameters, the UE can also be provided with a QoS flow description signaled over NAS.

As described below in reference to the examples that follow, in some scenarios, an out-of-order indication may be provided to UE 110 as part of QoS rules, a QoS flow description, or in a new list of 5QIs or QFIs that support selective OOD. UE 110 may use the rules to self-configure and support selective OOD for QoS flows, SDFs, SDU sets, PDU sets, etc., in accordance with the rules. Alternatively, UE 110 may use the rules to self-configure and support per-packet OOD for packets marked for OOD. In other scenarios, an out-of-order indication may be provided to SMF 220 as part of policy and charging control (PCC) rules. SMF 220 may create and distribute a packet detection rule (PDR), so that UPF 230 may know how to deliver each and every QFI, such that there may not be a need to convey this information from end-to-end over packet headers. SMF 220 may also inform RAN 120, over the N2 interface (e.g., in QoS characteristics) how to deliver each and every QFI. Doing so may result in different SDFs, IP flows, PDU sets, QoS flows, etc., to have different ordering behavior.

In some implementations, selective OOD may be implemented based on QFI pairs of primary and secondary QoS flows. For example, UPF 230 may be configured to match NAS QFIs with AS QFIs. QFI pairs (e.g., QFI_primary and QFI_secondary) that support selective OOD may be defined so that when the QFI of the primary QoS flow (QFI_primary) maps to a DRB, the corresponding secondary QFI (QFI_secondary) may be used to map to the same corresponding DRB. QFI_primary may be used for in-order delivery of traffic and QFI_secondary is used for out-of-order delivery of traffic. In another example, a global QFI pair for selective OOD may be implemented, where AS QFIs map to a global NAS QFI. In yet another example, UE 110 and UPF 230 may be configured to identified OOD traffic from non-OOD traffic of the same DRB.

The network (e.g., base station 122 or CN 130) may configure UE 110 for OOD to upper layers (e.g., media layers, IP layers, SDAP, etc.). In some implementations, the OOD configuration may be on a per radio bearer, per QoS flow, per PDU session, per RTP session, per XR traffic flow, per PDU set type, per SDF, or per-packet basis. In some scenarios, OOD may be indicted as a property of a QoS flow (e.g., in a new parameter). This may be indicated via the NAS layer as part of a QoS rule used to map a traffic flow to a QFI. Once configured, the NAS layer may inform the AS layer of the OOD property of this QFI. Alternatively, an OOD indication may be present in all packets of the QoS flow, using user plane packet headers from end-to-end between UE and UPF.

Endpoints (UE 110, base station 122, and UPF 230) may be configured separately via the control plane. UE 110 may receive OOD configuration via QoS rules or NAS signaling; base station 122 may receive OOD configuration via the N2 interface; and UPF 230 may receive OOD configuration in packet detection rules (PDRs). The configuration may come from the SMF 220 based on input from a policy control function (PCF) or application function (AF) (not shown). SMF 220 may provide an OOD list that contains 5QIs or QFIs with that support OOD. Alternatively, SMF 220 may provide an OOD flag in the characteristics of the QoS flow configuration, a QoS flow description of the NAS layer, or in a NAS QoS rule itself. Additionally, or alternatively, UE 110, base station 122, and UPF 230 may be configured to support a list of standardized 5QIs that support OOD. This may include a group of services (such as Internet, video, etc.) associated with a 5QI that specifically supports OOD for these services. Alternatively, a ‘delivery type’ with a value “in-order”/“out-of-order” could be defined in the QoS characteristics itself (as a QoS parameter associated with the 5QI) for direct indication of OOD.

In some implementations, OOD may be indicated as a property of a PDU set or PDU set type. In such implementations, the signaling may be over NAS or AS layers, as a parameter in a PDU set configuration (e.g., where a common description of the PDU set is provided). Alternatively, specific PDU sets can be signaled dynamically as OOD capable as part of PDU set related information that supports PDU set based handling (e.g., through an indication in a PDU set descriptor, in a PDU set header over the N3 interface in GTP-U, as part of a general PDU set header, or as part of meta-information (cross-layer).

In some implementations, OOD may be indicated as a property of a traffic flow or SDF. In such implementations, the property may be in the form of a characteristic in an SDF template, such as a special packet filter in a IP 5-tuple, or the presence of a header or payload based condition of RTP, secure RTP (SRTP), real-time transport control protocol (RTCP), or secure RTCP (SRTCP). In some implementations, the indication may be used for mapping of SDFs to QoS flows. Additionally, or alternatively, the indication may enable the use of primary QFIs and secondary QFIs, where the QFIs are paired and one QFI is associated with in-order delivery and the Other QFI is associated with OOD.

In some implementations, OOD may be indicated in a PDU header field that can be signaled over the user plane on a per-packet basis. In such implementations, the Uu, F1, and N3 interfaces may include the packet header field. Additionally, the indication may be a 1-bit indicator and may be for selected packets only. Additionally, or alternatively, OOD may be indicated via a set of characteristic based on packet header fields in upper layer payload (e.g. using deep packet inspection (DPI). In such implementations, the set of characteristics may be fixed (e.g., specified) as an option that may be enabled for certain protocols.

In some implementations, UL PDU session information may enable UPF 230 to receive control information (e.g., information elements (IEs) associated with the transfer of a packet over the N3 interface. Additionally, or alternatively, DL PDU session information may enable base station 222 to receive some control information (e.g., IEs) associated with the transfer of a packet over the N3 interface. To indicate OOD over N3 on a per-packet basis, a spare bit of an IE may be used, such as a spare bit corresponding to DL PDU session information format corresponding to a PDU Type 0, a spare bit corresponding to UL PDU session information format corresponding to a PDU Type 1, etc.

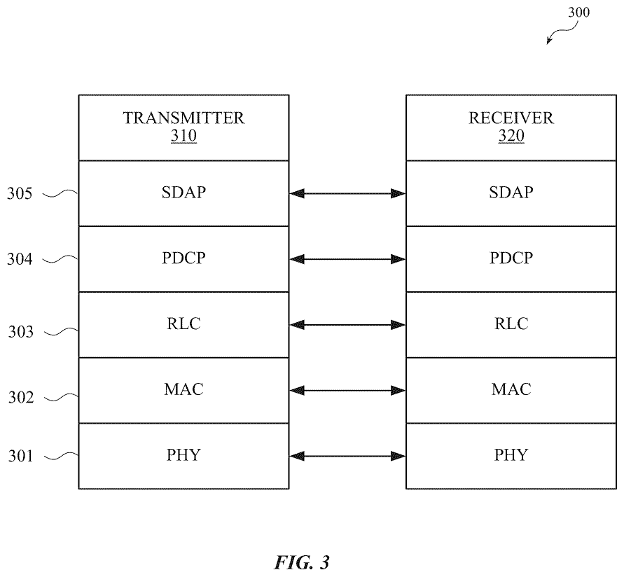

FIG. 3 is a diagram of an example of user plane protocol stacks 300 in accordance with one or more implementations described herein. User plane protocol stacks 300 may be implemented as a communications protocol between communication devices, such as UE 110, base station 122, UPF 230, etc., represented here as transmitter 310 and receiver 320.

The PHY layer 301 may transmit or receive information used by the MAC layer 302 over one or more air interfaces. The PHY layer 301 may further perform link adaptation or adaptive modulation and coding (AMC), power control, cell search (e.g., for initial synchronization and handover purposes), and other measurements used by higher layers, such as the RRC layer 305. The PHY layer 301 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 302 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 303 may operate in a plurality of modes of operation, including: Transparent Mode (TM), Unacknowledged Mode (UM), and/or Acknowledged Mode (AM). The RLC layer 303 may execute transfer of upper layer protocol data units (PDUs), error correction through automatic repeat request (ARQ) for AM data transfers, and concatenation, segmentation and reassembly of RLC SDUs for UM and AM data transfers. The RLC layer 303 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 304 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

Service Data Adaptation Protocol (SDAP) layer 305 may exists only in the user plane in both gNB and UE. SDAP layer 305 may interface to upper layers via QoS flows and to the PDCP lower layer via Data Radio Bearers (DRBs). Traffic from QoS flows may be mapped to suitable DRBs. When SDAP receives a PDU from upper layer flow (e.g., TCP/IP), the PDU is associated with QoS for this flow. SDAP layer 305 may map the flow to a DRB. Similarly, when a PDU is received at the PDCP, the PDU may contain an SDAP header which may be removed, and the PDU is passed to upper layer.

The UE and the RAN node may utilize a Uu interface (e.g., an NR interface) to exchange control plane data via a protocol stack comprising the PHY layer 301, the MAC layer 302, the RLC layer 303, the PDCP layer 304, and the RRC layer 305. Non-access stratum (NAS) protocols (not shown) may form a stratum of a control plane between the UE and the Core Network (CN). The NAS protocols may support the mobility of the UE and the session management procedures to establish and maintain IP connectivity between the UE and the network.

The main services and functions of the RRC layer 305 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. MIBs and SIBs may comprise one or more information elements (IEs), which may each comprise individual data fields or data structures.

The ODD configuration may be communicated via RRC messaging to configuration a DRB for operation with selective OOD or in-order delivery as new modes of the PDCP layer. Selective ODD may involve traffic in a QoS flow, PDU set, PDU set type, PDU session, RTP session, traffic flow or SDF. RRC may configure the PDCP layer (or if needed SDAP) with a sequence ordering property for one of these options, for example, in a new parameter in information element (IE) pdcp-config, sdap-config, or the like.

Per-packet OOD may be applicable to selected packets. Packets may be identified based on a new header fields (in GPRS tunnelling protocol user plane (GTP-U), over user plane protocols (e.g., on Uu or F1 interfaces), or based on meta info provided by implementation). Alternatively, selective OOD may be defined as a combined mode applicable to both per-packet and per-flow traffic, controlled by a single parameter. The new DRB mode(s) may distinguish between OOD for any packet (as in outOfOrderDelivery) versus OOD for selected packets only, and/or OOD for selected flows only.

UE capability information may be used or defined to enable those modes one or more of these modes. Additionally, or alternatively, a PDCP layer or entity may identify QoS flows/PDU sets based on upper layer configuration or based on DRB/RLC entity mapping (which in turn may be controlled by base station 122 (e.g., over GTP-U and N2/N3 interface configuration). Similar to legacy outOfOrderDelivery, RRC may not configure selective OOD or per-packet OOD together with UDC or RoHC.

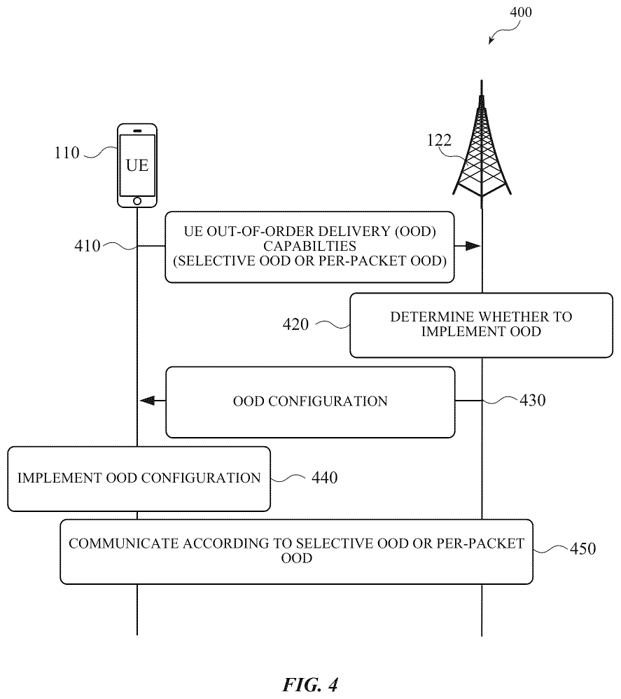

FIG. 4 is a diagram of an example process 400 for out-of-order delivery (OOD) according to one or more implementations described herein. Process 400 may be implemented by UE 110 and one or more base stations 122. In some implementations, some or all of process 400 may be performed by one or more other systems or devices, including one or more of the devices of FIG. 1 or 2, such as a function of CN 130. Additionally, process 400 may include one or more fewer, additional, differently ordered and/or arranged operations than those shown in FIG. 4. In some implementations, some or all of the operations of process 400 may be performed independently, successively, simultaneously, etc., of one or more of the other operations of process 400. As such, the techniques described herein are not limited to a number, sequence, arrangement, timing, etc., of the operations or process depicted in FIG. 4.

As shown, process 400 may include UE 110 providing base station 122 with UE capability information (at 410). The UE capability information may include an indication of whether UE 110 is capable of communicating via out-of-order delivery (OOD), per-packet OOD, and/or selective OOD. UE 110 may provide the UE capability information as part of an access or attachment procedure or as part of another type of procedure to establish or update communications between UE 110 and base station 122. In some implementations, UE 110 may provide the UE capability information as part of a procedure to establish a DRB with base station 122.

OOD may include an ability of a PDCP layer of UE 110 to immediately relay received data units (PDUs, SDUs, etc.) to higher layers of UE 110 (e.g., regardless of whether the data units are received by the PDCP layer in order. In such a scenario, the data units may be reordered by one of the higher layers of UE 110. Selective OOD may include OOD that may apply to traffic in a QoS flow, PDU set, PDU set type, PDU session, RTP session, traffic flow or SDF. Per-packet OOD may include an ability of a PDCP layer of UE 110 to immediately relay received information on a per-packet basis. For example, UE 110 may determine whether a received packet indicates that the packet is designated for OOD and process the packet accordingly. Packets may be identified for OOD based on a packet header field, via a GPRS tunnelling protocol user plane (GTP-U and N2/N3 configuration), over a user plane protocol, or based on meta information that may be implementation-specific.

In some implementations, selective OOD may refer to a combined OOD mode applicable to both per-packet and per-flow traffic. In some implementations, selective OOD or per-packet OOD may involve a PDCP layer of UE 110 identifying a QoS flow or a PDU set for OOD based on a configuration of an upper layer. Additionally, or alternatively, selective OOD or per-packet OOD may involve a PDCP layer of UE 110 identifying a QoS flow or a PDU set for OOD based on DRB or RLC entity mapping, which may be controlled by base station 122 via GTP-U configuration). Thus, while standard OOD may cause UE 110 to apply OOD to all traffic and packets of a DRB, selective OOD and per-packet OOD may cause UE 110 to apply OOD to certain types of traffic, certain packets, or certain packets of certain types of traffic.

Process 400 may include base station 122 determining whether to apply OOD (block 420). For example, base station 122 may determine whether to implement OOD with UE 110 based on the OOD capabilities indicated by UE 110. In some implementations, base station 122 may also determine how and which type of OOD to be implement. For instance, base station 122 may determine whether UE 110 is to implement selective or per-packet OOD, in addition to how OOD is to be indicated or differentiated from in-order delivery (e.g., via different traffic flows, QFIs, packet header indications, etc.). Base station 122 may generate an OOD configuration based on this determination and may provide the OOD configuration to UE 110 (block 430). UE 110 may apply the OOD configuration received from base station 122 (block 440), and UE 110 and base station 122 may communicate using selective OOD or per-packet OOD (block 450).

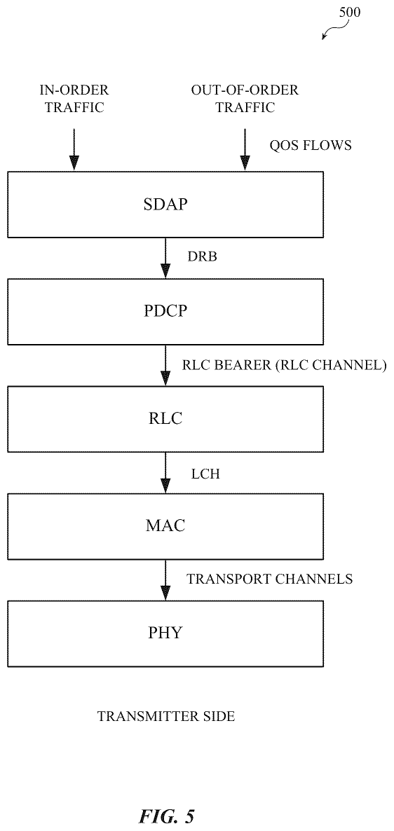

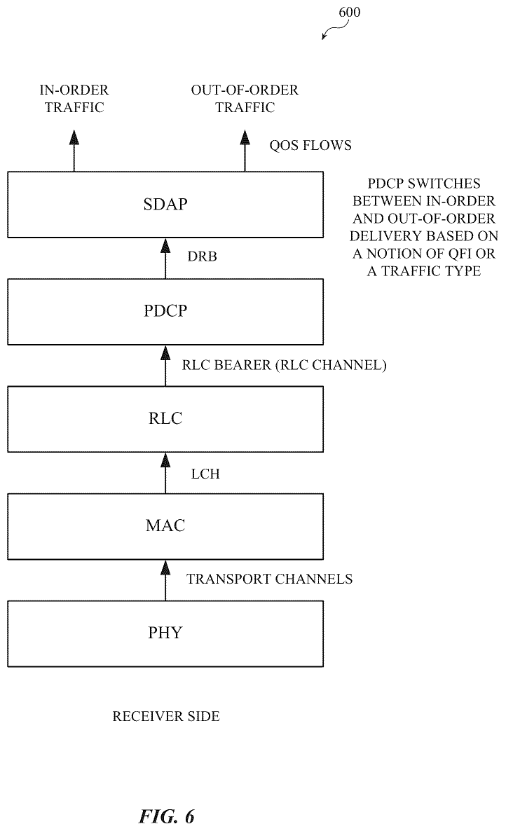

FIGS. 5-6 are diagrams of examples of a user plane stack of a transmitter 500 and corresponding user plane stack of a receiver 600 according to one or more implementations described herein. The transmitter may be implemented as UE 110, base station 122, UPF 230, or another device or entity of FIGS. 1-2.

Traffic may be one or more PDU set types of the same ordering characteristic; one or more PDUs of the same ordering characteristic in a PDU set; or one or more SDAP SDUs of the same ordering characteristic. Alternatively, traffic may be represented by one or more traffic flows of the same ordering characteristic; one or more SDFs of the same ordering characteristic; or one or multiple QoS flows of the same ordering characteristic. The ordering characteristic may be whether the traffic configured for in-order delivery or OOD.

In some implementations, the delivery of packets to upper layers, e.g., over the Uu interface, may include two types of delivery flows. One type may include PDU sets or QoS flows of an in-order delivery (by the PDCP receiver). The other type may include PDU sets or QoS flows of an OOD (by the PDCP receiver). Alternatively, the delivery of packets to upper layers, e.g., over the Uu interface, may include a primary QoS and a secondary QoS. The primary QoS flow may be for in-order delivery traffic (by the PDCP receiver), and the secondary QoS flow may be for OOD traffic (by the PDCP receiver).

Referring to FIG. 6, the PDCP of receiver 600 may be configured to identify a QFI by inspecting the payload of the PDCP SDU, which may occur after an integrity check. The PDCP may also, or alternatively, be configured to detect a primary/secondary indication or an out-of-order flag (e.g., a 1 bit indicator) in a PDCP header or an SDAP header. In some implementations, the PDCP of receiver 600 may use deep packet inspection techniques to decide whether in-order or out-of-order delivery should be applied. For example, the PDCP may inspect the contents of TCP ACK packets, domain name system (DNS) packets, TCP 3-way handshake packets, real-time transport protocol (RTCP) packets, and other packets for indications of being eligible for OOD. Traffic flows may be arranged according to types of delivery flows (e.g., in-order delivery and OOD) or according to a primary QoS flow (e.g., for in-order delivery) and secondary QoS (e.g., for OOD).

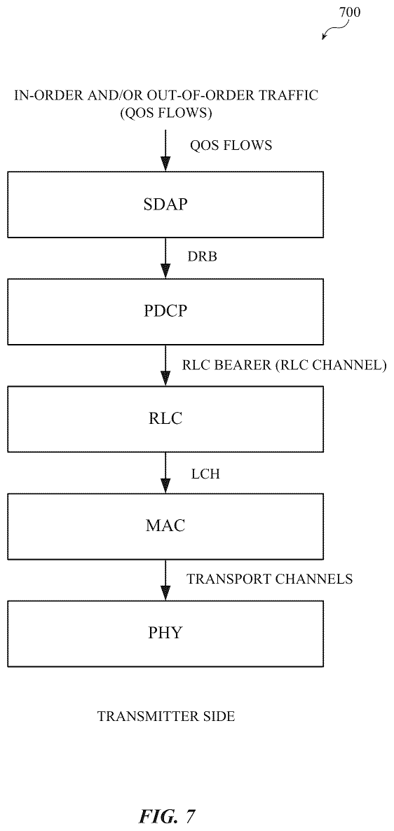

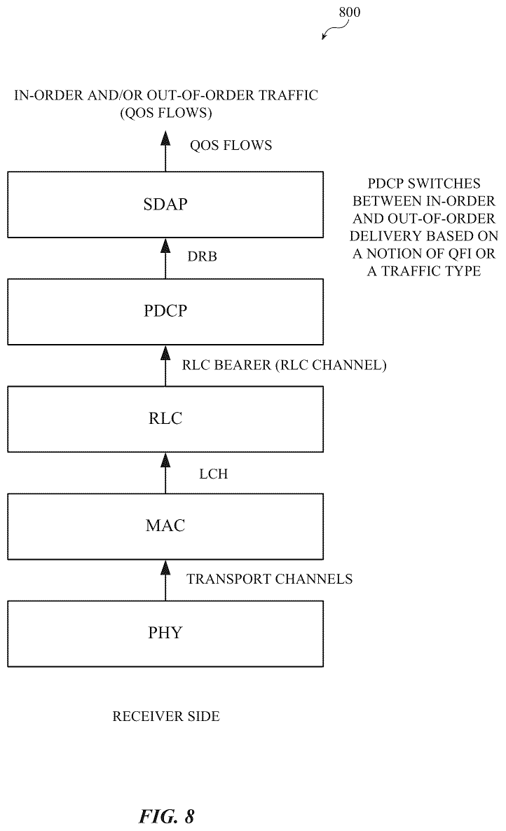

FIGS. 7-8 are diagrams of examples of a user plane stack of a transmitter 700 and corresponding user plane stack of a receiver 800 according to one or more implementations described herein. The transmitter may be implemented as UE 110, base station 122, UPF 230, or another device or entity of FIGS. 1-2.

Traffic may be one or more PDU set types of different reordering characteristic; one or more PDUs of different reordering characteristic in a PDU set; or one or more SDAP SDUs of different reordering characteristic. Alternatively, traffic may be represented by one or more traffic flows of different reordering characteristic; one or more SDFs of different reordering characteristic; or one or multiple QoS flows of different reordering characteristic. The ordering characteristic may be whether the traffic configured for in-order delivery or OOD.

In some implementations, the SDAP layer or PDCP layer of transmitter 700 may modify a packet header field to indicate wither the packet is configured for OOD on a per-packet basis. Alternatively, no new packet header field may be added for indicating OOD, and receiver 800 may be configured to detect whether packets are for in-order delivery or OOD based on UE/gNB implementation (for example, by deep packet inspection, evaluating the configuration characteristics of higher layer mappings, meta data, or another implementation-specific method.

Referring to FIG. 8, receiver 800 may be configured to switch, on a per-packet basis, between in-order and out-of-order delivery based on a packet header field (in the PDCP or SDAP) configured to indicate a delivery mode (e.g., in-order delivery or OOD). Alternatively, receiver 800 may be configured to detect the delivery mode based on the implementation. For example, receiver 800 may use deep packet inspection (e.g., of PDCP SDUs), evaluate configuration characteristics of higher layer mappings, meta data, or another implementation based method. In some implementations, when receiver 800 determines the delivery mode of a packet, receiver 800 may determine the QFI of the packet, and apply the same delivery mode to other packets with the same QFI. Thus, receiver 800 may map the delivery mode to a QFI use the QFI to determine the delivery mode for other packets with the same QFI.

In some implementations, sequence ordering or delivery may be determined by receiver 800 based on the QFI itself or a related pair of QFIs. For example, some QFIs may be reserved for indicating in-order delivery while others may be reserved for indicating OOD. For instance: in-order traffic may use even QFI values and out-of-order traffic may use odd QFI values. In another example, QFI values within different ranges of QFI values may indicate in-order traffic and out-of-order traffic. Alternatively, certain QFI values may be operator or vendor specific. In yet other examples, a rule may be applied, such as any QFI x without OOD has a matching QFI with OOD at QFI y, where y=f(x). In some implementations, sequence ordering or delivery may be determined by receiver 800 based on an end-to-end mechanism for allocation and association of QFIs to in-order and out-of-order traffic. In other scenarios, in-order QFIs may be considered a primary QFI and out-of-order QFIs may be considered a secondary QFI, and secondary QFIs may only be present (e.g., used) when OOD traffic is present. Thus, receiver 800 may determine the delivery mode of traffic based on the value of the QFI itself.

In some implementations, upper layers (e.g., SA4 layers, TCI/IP layers, etc.) may provide lower layers (e.g., SDAP layer, PDCP layer, etc.) with an indication of the delivery mode. In such implementations, the indication may be provided as part of a real-time protocol RTP, where an upper, media, or IP layer informs the lower layers of the OOD configuration; and the lower layers (e.g., SDAP or PDCP) apply the respective configuration for the traffic flow, RTP session/stream, PDU session, QoS flow, PDU set, PDU set type, DRB, or logical channel (LCH). In some implantations, the upper layer may be a NAS layer.

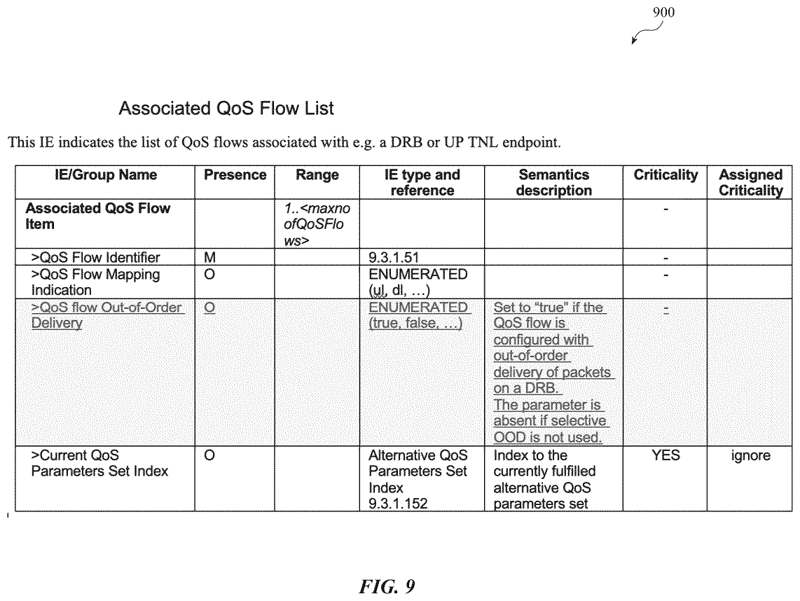

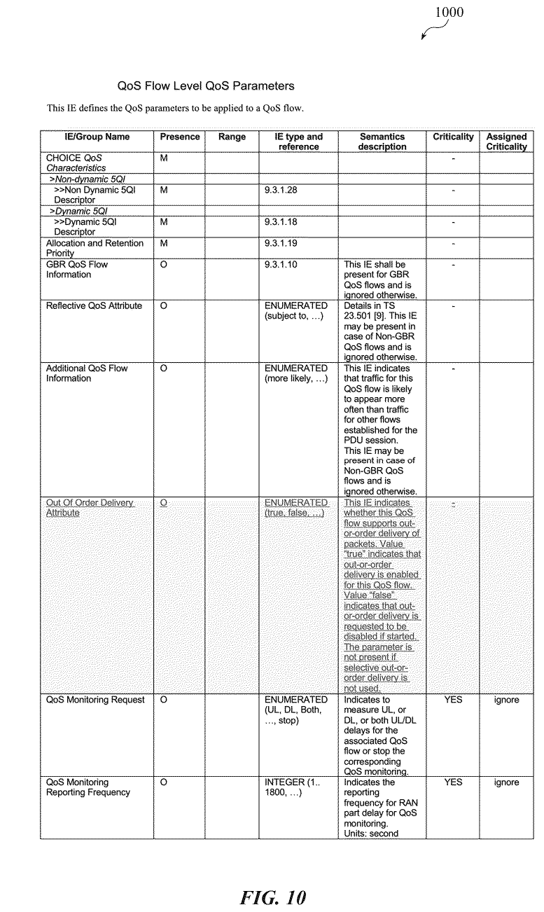

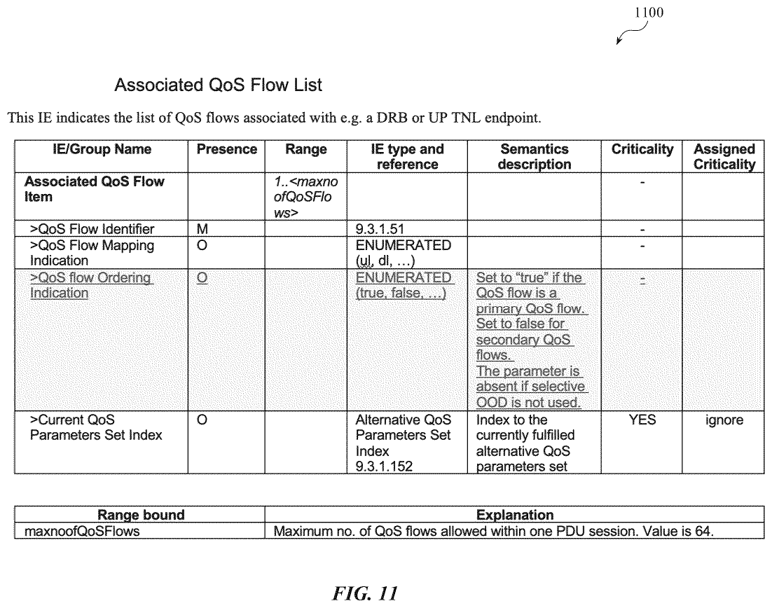

FIGS. 9-11 are diagrams of example information elements (IEs) 900, 1000, 1100 of QoS flow characteristics according to one or more implementations described herein. IE 900 includes a table of QoS flows associated with a DRB or endpoint. IE 1000 includes a table of QoS flow level QoS parameters. IE 1100 includes a table of QoS flows, with a maximum number of QoS flows, associated with a DRB or endpoint. As shown, IEs 900, 1000, 1100 each include a QoS flow ordering indication parameter, which may be used to indicate whether the corresponding QoS flow supports OOD. UE 110, base station 122, and/or UPF 230 may use IEs 900, 1000, 1100 to indicate when ODD is to be applied or supported.

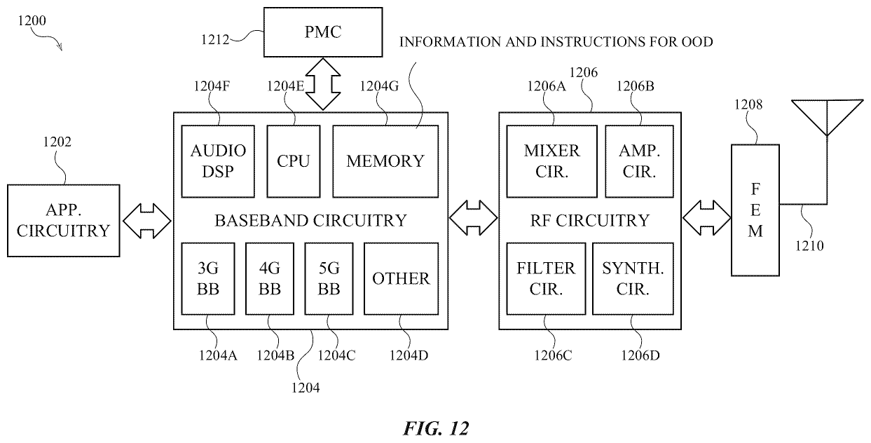

FIG. 12 is a diagram of an example of components of a device according to one or more implementations described herein. In some implementations, the device 1200 can include application circuitry 1202, baseband circuitry 1204, RF circuitry 1206, front-end module (FEM) circuitry 1208, one or more antennas 1210, and power management circuitry (PMC) 1212 coupled together at least as shown. The components of the illustrated device 1200 can be included in a UE or a RAN node. In some implementations, the device 1200 can include fewer elements (e.g., a RAN node may not utilize application circuitry 1202, and instead include a processor/controller to process IP data received from a CN or an Evolved Packet Core (EPC)). In some implementations, the device 1200 can include additional elements such as, for example, memory/storage, display, camera, sensor (including one or more temperature sensors, such as a single temperature sensor, a plurality of temperature sensors at different locations in device 1200, etc.), or input/output (I/O) interface. In other implementations, the components described below can be included in more than one device (e.g., said circuitries can be separately included in more than one device for Cloud-RAN (C-RAN) implementations).

The application circuitry 1202 can include one or more application processors. For example, the application circuitry 1202 can include circuitry such as, but not limited to, one or more single-core or multi-core processors. The processor(s) can include any combination of general-purpose processors and dedicated processors (e.g., graphics processors, application processors, etc.). The processors can be coupled with or can include memory/storage and can be configured to execute instructions stored in the memory/storage to enable various applications or operating systems to run on the device 1200. In some implementations, processors of application circuitry 1202 can process IP data packets received from an EPC.

The baseband circuitry 1204 can include circuitry such as, but not limited to, one or more single-core or multi-core processors. The baseband circuitry 1204 can include one or more baseband processors or control logic to process baseband signals received from a receive signal path of the RF circuitry 1206 and to generate baseband signals for a transmit signal path of the RF circuitry 1206. Baseband circuitry 1204 can interface with the application circuitry 1202 for generation and processing of the baseband signals and for controlling operations of the RF circuitry 1206. For example, in some implementations, the baseband circuitry 1204 can include a 3G baseband processor 1204A, a 4G baseband processor 1204B, a 5G baseband processor 1204C, or other baseband processor(s) 1204D for other existing generations, generations in development or to be developed in the future (e.g., 5G, 6G, etc.). The baseband circuitry 1204 (e.g., one or more of baseband processors 1204A-D) can handle various radio control functions that enable communication with one or more radio networks via the RF circuitry 1206. In other implementations, some or all of the functionality of baseband processors 1204A-D can be included in modules stored in the memory 1204G and executed via a Central Processing Unit (CPU) 1204E. The radio control functions can include, but are not limited to, signal modulation/demodulation, encoding/decoding, radio frequency shifting, etc. In some implementations, modulation/demodulation circuitry of the baseband circuitry 1204 can include Fast-Fourier Transform (FFT), precoding, or constellation mapping/de-mapping functionality. In some implementations, encoding/decoding circuitry of the baseband circuitry 1204 can include convolution, tail-biting convolution, turbo, Viterbi, or Low-Density Parity Check (LDPC) encoder/decoder functionality. Implementations of modulation/demodulation and encoder/decoder functionality are not limited to these examples and can include other suitable functionality in other implementations.

In some implementations, memory 1204G may receive and/or store information and instructions for communicating, via a wireless communication network, information as in-order traffic; and communicating, via the wireless communication network, information using out-of-order traffic. The out-of-order traffic may comprise selective out-of-order delivery OOD or per-packet OOD delivery. Additional examples and features are also described herein. In some implementations, the baseband circuitry 1204 can include one or more audio digital signal processor(s) (DSP) 1204F. The audio DSPs 1204F can include elements for compression/decompression and echo cancellation and can include other suitable processing elements in other implementations. Components of the baseband circuitry can be suitably combined in a single chip, a single chipset, or disposed on a same circuit board in some implementations. In some implementations, some or all of the constituent components of the baseband circuitry 1204 and the application circuitry 1202 can be implemented together such as, for example, on a system on a chip (SOC).

In some implementations, the baseband circuitry 1204 can provide for communication compatible with one or more radio technologies. For example, in some implementations, the baseband circuitry 1204 can support communication with a NG-RAN, an evolved universal terrestrial radio access network (EUTRAN) or other wireless metropolitan area networks (WMAN), a wireless local area network (WLAN), a wireless personal area network (WPAN), etc. Implementations in which the baseband circuitry 1204 is configured to support radio communications of more than one wireless protocol can be referred to as multi-mode baseband circuitry.

RF circuitry 1206 can enable communication with wireless networks using modulated electromagnetic radiation through a non-solid medium. In various implementations, the RF circuitry 1206 can include switches, filters, amplifiers, etc. to facilitate the communication with the wireless network. RF circuitry 1206 can include a receive signal path which can include circuitry to down-convert RF signals received from the FEM circuitry 1208 and provide baseband signals to the baseband circuitry 1204. RF circuitry 1206 can also include a transmit signal path which can include circuitry to up-convert baseband signals provided by the baseband circuitry 1204 and provide RF output signals to the FEM circuitry 1208 for transmission.

In some implementations, the receive signal path of the RF circuitry 1206 can include mixer circuitry 1206A, amplifier circuitry 1206B and filter circuitry 1206C. In some implementations, the transmit signal path of the RF circuitry 1206 can include filter circuitry 1206C and mixer circuitry 1206A. RF circuitry 1206 can also include synthesizer circuitry 1206D for synthesizing a frequency for use by the mixer circuitry 1206A of the receive signal path and the transmit signal path. In some implementations, the mixer circuitry 1206A of the receive signal path can be configured to down-convert RF signals received from the FEM circuitry 1208 based on the synthesized frequency provided by synthesizer circuitry 1206D. The amplifier circuitry 1206B can be configured to amplify the down-converted signals and the filter circuitry 1206C can be a low-pass filter (LPF) or band-pass filter (BPF) configured to remove unwanted signals from the down-converted signals to generate output baseband signals. Output baseband signals can be provided to the baseband circuitry 1204 for further processing. In some implementations, the output baseband signals can be zero-frequency baseband signals, although this is not a requirement. In some implementations, mixer circuitry 1206A of the receive signal path can comprise passive mixers, although the scope of the implementations is not limited in this respect.

In some implementations, the mixer circuitry 1206A of the transmit signal path can be configured to up-convert input baseband signals based on the synthesized frequency provided by the synthesizer circuitry 1206D to generate RF output signals for the FEM circuitry 1208. The baseband signals can be provided by the baseband circuitry 1204 and can be filtered by filter circuitry 1206C.

In some implementations, the mixer circuitry 1206A of the receive signal path and the mixer circuitry 1206A of the transmit signal path can include two or more mixers and can be arranged for quadrature down conversion and up conversion, respectively. In some implementations, the mixer circuitry 1206A of the receive signal path and the mixer circuitry 1206A of the transmit signal path can include two or more mixers and can be arranged for image rejection (e.g., Hartley image rejection). In some implementations, the mixer circuitry 1206A of the receive signal path and the mixer circuitry 1406A can be arranged for direct down conversion and direct up conversion, respectively. In some implementations, the mixer circuitry 1206A of the receive signal path and the mixer circuitry 1206A of the transmit signal path can be configured for super-heterodyne operation.

In some implementations, the output baseband signals, and the input baseband signals can be analog baseband signals, although the scope of the implementations is not limited in this respect. In some alternate implementations, the output baseband signals, and the input baseband signals can be digital baseband signals. In these alternate implementations, the RF circuitry 1206 can include analog-to-digital converter (ADC) and digital-to-analog converter (DAC) circuitry and the baseband circuitry 1204 can include a digital baseband interface to communicate with the RF circuitry 1206.

In some dual-mode implementations, a separate radio IC circuitry can be provided for processing signals for each spectrum, although the scope of the implementations is not limited in this respect.

In some implementations, the synthesizer circuitry 1206D can be a fractional-N synthesizer or a fractional N/N+1 synthesizer, although the scope of the implementations is not limited in this respect as other types of frequency synthesizers can be suitable. For example, synthesizer circuitry 1206D can be a delta-sigma synthesizer, a frequency multiplier, or a synthesizer comprising a phase-locked loop with a frequency divider.

The synthesizer circuitry 1206D can be configured to synthesize an output frequency for use by the mixer circuitry 1206A of the RF circuitry 1206 based on a frequency input and a divider control input. In some implementations, the synthesizer circuitry 1206D can be a fractional N/N+1 synthesizer.

In some implementations, frequency input can be provided by a voltage-controlled oscillator (VCO), although that is not a requirement. Divider control input can be provided by either the baseband circuitry 1204 or the applications circuitry 1202 depending on the desired output frequency. In some implementations, a divider control input (e.g., N) can be determined from a look-up table based on a channel indicated by the applications circuitry 1202.

Synthesizer circuitry 1206D of the RF circuitry 1206 can include a divider, a delay-locked loop (DLL), a multiplexer and a phase accumulator. In some implementations, the divider can be a dual modulus divider (DMD) and the phase accumulator can be a digital phase accumulator (DPA). In some implementations, the DMD can be configured to divide the input signal by either N or N+1 (e.g., based on a carry out) to provide a fractional division ratio. In some example implementations, the DLL can include a set of cascaded, tunable, delay elements, a phase detector, a charge pump and a D-type flip-flop. In these implementations, the delay elements can be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 1206D can be configured to generate a carrier frequency as the output frequency, while in other implementations, the output frequency can be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency can be a LO frequency (fLO). In some implementations, the RF circuitry 1206 can include an IQ/polar converter.

FEM circuitry 1208 can include a receive signal path which can include circuitry configured to operate on RF signals received from one or more antennas 1210, amplify the received signals and provide the amplified versions of the received signals to the RF circuitry 1206 for further processing. FEM circuitry 1208 can also include a transmit signal path which can include circuitry configured to amplify signals for transmission provided by the RF circuitry 1206 for transmission by one or more of the one or more antennas 1210. In various implementations, the amplification through the transmit or receive signal paths can be done solely in the RF circuitry 1206, solely in the FEM circuitry 1208, or in both the RF circuitry 1206 and the FEM circuitry 1208.

In some implementations, the FEM circuitry 1208 can include a TX/RX switch to switch between transmit mode and receive mode operation. The FEM circuitry can include a receive signal path and a transmit signal path. The receive signal path of the FEM circuitry can include an LNA to amplify received RF signals and provide the amplified received RF signals as an output (e.g., to the RF circuitry 1206). The transmit signal path of the FEM circuitry 1208 can include a power amplifier (PA) to amplify input RF signals (e.g., provided by RF circuitry 1206), and one or more filters to generate RF signals for subsequent transmission (e.g., by one or more of the one or more antennas 1210).

In some implementations, the PMC 1212 can manage power provided to the baseband circuitry 1204. In particular, the PMC 1212 can control power-source selection, voltage scaling, battery charging, or DC-to-DC conversion. The PMC 1212 can often be included when the device 1200 is capable of being powered by a battery, for example, when the device is included in a UE. The PMC 1212 can increase the power conversion efficiency while providing desirable implementation size and heat dissipation characteristics.

While FIG. 12 shows the PMC 1212 coupled only with the baseband circuitry 1204. However, in other implementations, the PMC 1212 may be additionally or alternatively coupled with, and perform similar power management operations for, other components such as, but not limited to, application circuitry 1202, RF circuitry 1206, or FEM circuitry 1208.

In some implementations, the PMC 1212 can control, or otherwise be part of, various power saving mechanisms of the device 1200. For example, if the device 1200 is in an RRC_Connected state, where it is still connected to the RAN node as it expects to receive traffic shortly, then it can enter a state known as Discontinuous Reception Mode (DRX) after a period of inactivity. During this state, the device 1200 can power down for brief intervals of time and thus save power.

If there is no data traffic activity for an extended period of time, then the device 1200 can transition off to an RRC_Idle state, where it disconnects from the network and does not perform operations such as channel quality feedback, handover, etc. The device 1200 goes into a very low power state and it performs paging where again it periodically wakes up to listen to the network and then powers down again. The device 1200 may not receive data in this state; in order to receive data, it can transition back to RRC_Connected state.

An additional power saving mode can allow a device to be unavailable to the network for periods longer than a paging interval (ranging from seconds to a few hours). During this time, the device is unreachable to the network and can power down completely. Any data sent during this time incurs a large delay and it is assumed the delay is acceptable.

Processors of the application circuitry 1202 and processors of the baseband circuitry 1204 can be used to execute elements of one or more instances of a protocol stack. For example, processors of the baseband circuitry 1204, alone or in combination, can be used execute Layer 3, Layer 2, or Layer 1 functionality, while processors of the baseband circuitry 1204 can utilize data (e.g., packet data) received from these layers and further execute Layer 4 functionality (e.g., transmission communication protocol (TCP) and user datagram protocol (UDP) layers). As referred to herein, Layer 3 can comprise a RRC layer, described in further detail below. As referred to herein, Layer 2 can comprise a medium access control (MAC) layer, a radio link control (RLC) layer, and a packet data convergence protocol (PDCP) layer, described in further detail below. As referred to herein, Layer 1 can comprise a physical (PHY) layer of a UE/RAN node, described in further detail below.

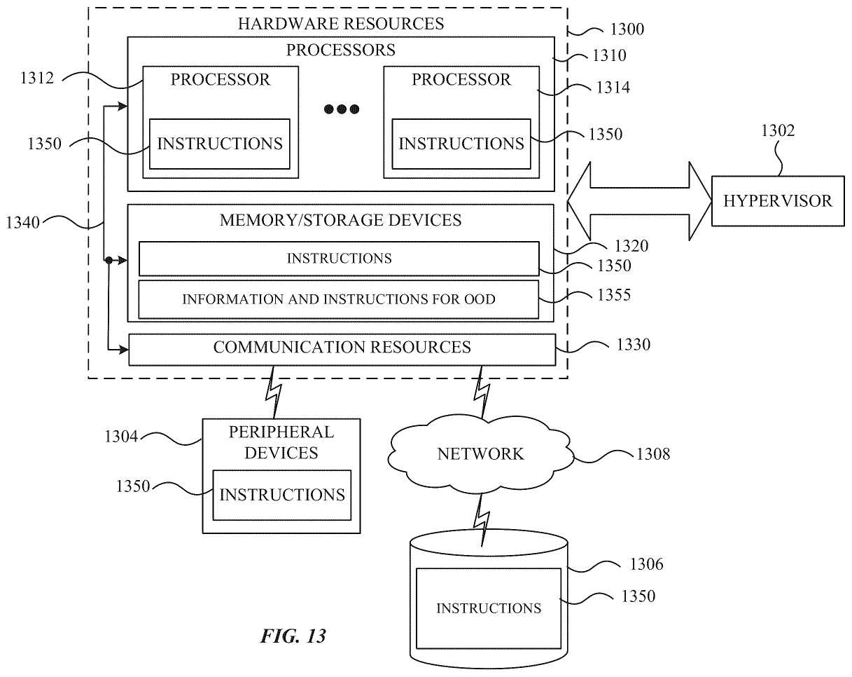

FIG. 13 is a block diagram illustrating components, according to some example implementations, able to read instructions from a machine-readable or computer-readable medium (e.g., a non-transitory machine-readable storage medium) and perform any one or more of the methodologies discussed herein. Specifically, FIG. 13 shows a diagrammatic representation of hardware resources 1300 including one or more processors (or processor cores) 1310, one or more memory/storage devices 1320, and one or more communication resources 1330, each of which may be communicatively coupled via a bus 1340. For implementations where node virtualization (e.g., NFV) is utilized, a hypervisor 1302 may be executed to provide an execution environment for one or more network slices/sub-slices to utilize the hardware resources 1300.

The processors 1310 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1312 and a processor 1314.

The memory/storage devices 1320 may include main memory, disk storage, or any suitable combination thereof. The memory/storage devices 1320 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

In some implementations, memory/storage devices 1320 receive and/or store information and instructions 1355 for communicating, via a wireless communication network, information as in-order traffic; and communicating, via the wireless communication network, information using out-of-order traffic. The out-of-order traffic may comprise selective out-of-order delivery OOD or per-packet OOD delivery. Additional examples and features are also described herein.

The communication resources 1330 may include interconnection or network interface components or other suitable devices to communicate with one or more peripheral devices 1304 or one or more databases 1306 via a network 1308. For example, the communication resources 1330 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1350 may comprise software, a program, an application, an applet, an app, or other executable code for causing at least any of the processors 1310 to perform any one or more of the methodologies discussed herein. The instructions 1350 may reside, completely or partially, within at least one of the processors 1310 (e.g., within the processor's cache memory), the memory/storage devices 1320, or any suitable combination thereof. Furthermore, any portion of the instructions 1350 may be transferred to the hardware resources 1300 from any combination of the peripheral devices 1304 or the databases 1306. Accordingly, the memory of processors 1310, the memory/storage devices 1320, the peripheral devices 1304, and the databases 1306 are examples of computer-readable and machine-readable media.

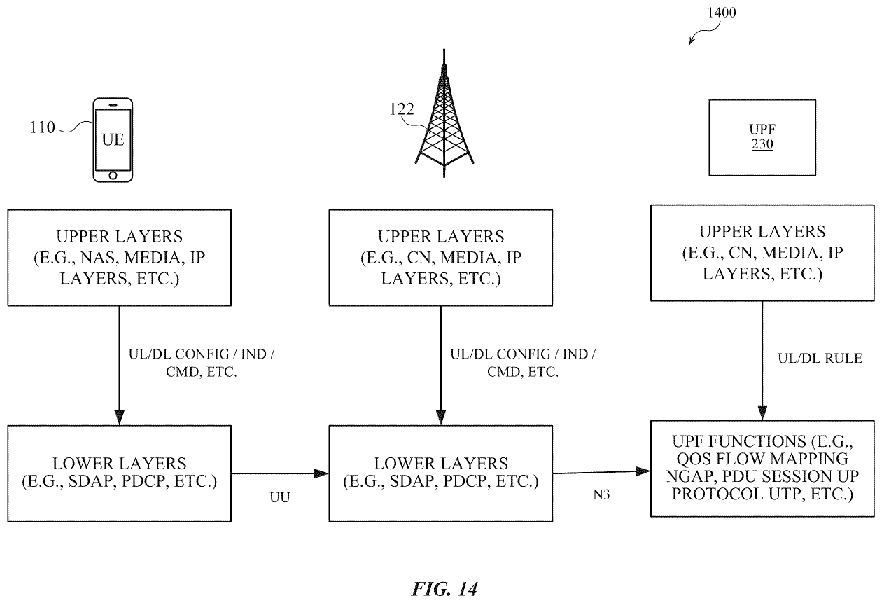

FIG. 14 is a diagram of an example 1400 of devices, layers, and interfaces according to one or more implementations described herein. As shown, example 1400 includes UE 110, base station 122, and UPF 230, each with upper layers and lower layers. In practice, upper layers (such as an application server or an application function) may provide input to the CN 130 (e.g., the SMF), which in turn may inform UPF 230 (e.g., as “upper layers) via the N4 interface. A Uu interface may exist between the lower layers of UE 110 and base station 122, and an N3 interface may exist between the lower layers of base station 122 and UPF 230.

The upper layers of UE 110 may include a NAS layer, a media layer, and IP layer, or meta information base on an implementation of UE 110. The upper layers of base station 1220 may include a core network function (such as SMF 220), a media layer, and IP layer, or meta information base on an implementation of base station 222. The upper layers of UPF 230 may include a core network function (such as SMF 220), a media layer, and IP layer, or meta information base on an implementation of SMF UPF 230. Each of the lower layers of UE 110 and base station 122 may include an access stratum (AS) layer such as a SDAP layer and/or SDCP layer. The UPF 230 may include support for QoS flow mapping, next generation (NG) application protocol, PDU session UP protocol, GTP, etc.

The upper layers of UE 110 may send UL configuration information and/or DL configuration information, an indication, a command, etc., to the lower layers of UE 110 to indicate whether a given traffic flow is to be sent and received in accordance with ODD. A media layer may also be referred to as a multimedia layer or an SA4 layer. Similarly, the upper layers of base station 122 may send UL configuration information and/or DL configuration information, an indication, a command, etc., to the lower layers of base station 122 to indicate whether a given traffic flow is to be sent and received in accordance with ODD. UPF 230 may receive a UL rule and/or DL rule for processing UL and/or DL traffic according to one or more deliver modes (e.g., in-order deliver (IOD), selective OOD, and/or per-packet OOD). UPF 230 may receive information for doing so via the N4 interface from SMF 220.

For example, an upper layer, such as a media layer, SA4 layer, IP layer, etc., may provide a lower layer with an indication that a corresponding traffic flow is configured for OOD, and the lower layers (e.g., the SDAP layer or PDCP layer) may apply the OOD configuration to the traffic flow, RTP session, streaming session, PDU session, QoS flow, PDU set, PDU set type, DRB, or logical channel. In some implementations, the indication of the delivery mode may also, or alternatively come from a NAS layer.

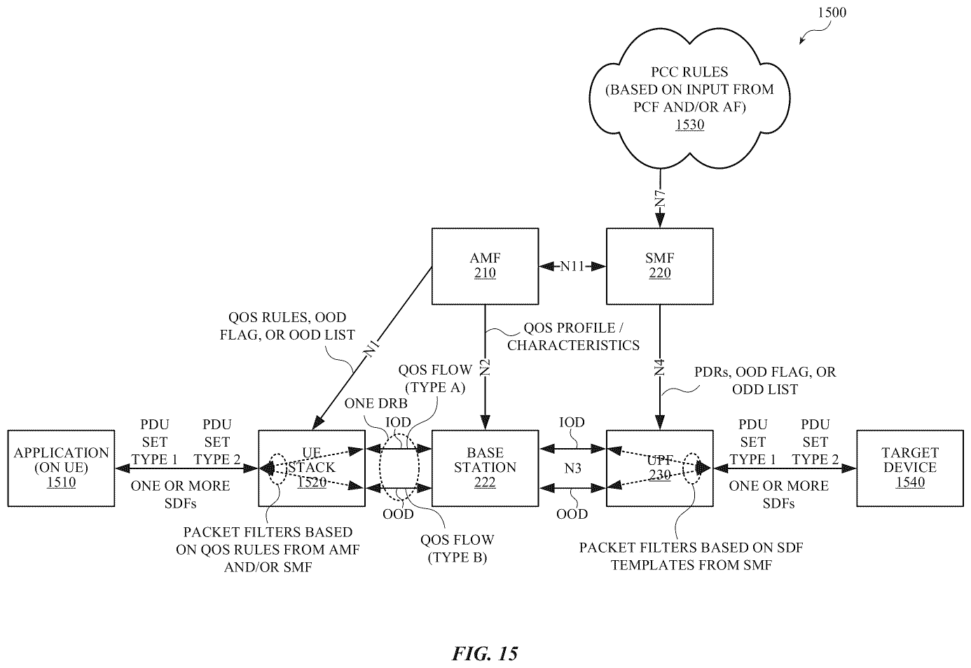

FIG. 15 is a diagram of an example 1500 of PDCP in-order deliver (IOD) and OOD according to one or more implementations described herein. As shown, example 1500 may include an application (on a UE 110) 1510, a UE stack 1520, base station 222, AMF 210, SMF 220, PCC rules 1530, UPF 230, and target device 1540. In some implementations, example 1500 may include one or more fewer, additional, differently ordered and/or arranged entities or devices than those shown in FIG. 15. Additionally, one or more operations described as being performed by one entity or device may instead by performed by another entity or device or a combination of entities and devices than those shown in FIG. 15.

Application 1510 and UE stack 1520 may be internal to UE 110 and may communicate one or more SDFs between each other. Some SDFs may correspond to PDU set type 1 and other SDFs may correspond to PDF set type 2. For purposes of explaining FIG. 15, assume that PDU set type 1 is configured for IOD and PDU set type 2 is configured for OOD. UE stack 1520 may receive, vi an N1 interface, QoS rules, OOD flags, or OOD lists for processing SDFs according to different PDU set types from AMF 210. In some implementations, the QoS rules, OOD flags, or OOD lists may also, or alternatively be received from SMF 220.

UE stack 1520 may process the SDFs according to the QoS rules, OOD flags, or OOD lists. For SDFs intended for target device 1540 (e.g., an application server, another UE 110, etc.), UE stack 1520 may ensure that traffic flows of each PDS set type 2 are flagged or processed for delivery properly (e.g., according to the QoS rules, OOD flags, or OOD lists) (see, for example, FIG. 5). For SDFs intended for application 1510, UE stack 1520 may use the QoS rules, OOD flags, or OOD lists to determine whether a given traffic flow is configured for IOD or OOD and process the PDUs accordingly.

UE stack 1520 may use one DRB to send and receive QoS flows from base station 222. The DRB may include QoS flows of type A (e.g., for IOD) and QoS flow type B (e.g., for OOD). Similarly, base station 222 may also send and receive QoS flows from UPF 230. And some of the QoS flows from UPF 230 may include traffic flows configured for IOD and traffic flows configured for OOD. Base station 222 may receive QoS profiles and/or characteristics from AMF 210 via an N2 interface. The QoS profiles and/or characteristics may indicate which types of QoS flows are to be delivered using IOD and which are to be delivered using OOD. Base station may use the QoS profiles and/or characteristics to map QoS flows to QoS flow types and/or delivery types (e.g., IOD or OOD) and process or relay the QoS flows accordingly (see, for example, FIG. 6).

SMF 220 may receive, via an N7 interface, policy charging and control (PCC) rules that are based on a policy control function (PCF) and/or an application function (AF) (e.g., of CN 130). The PCC rules may indicate how different traffic flows or packets are to be communicated throughout the network and/or delivered. SMF 220 may determine, based on the PCC rules, QoS profiles and/or characteristics that are provided to base station 122. Additionally, or alternatively, SMF 220 may determine, based on the PCC rules, packet detection rules (PDRs), OOD flags, and/or OOD lists provided to UPF 230. The PCC rules, packet detection rules (PDRs), OOD flags, and/or OOD lists may provide UPF 230 with a template for filtering and processing packets relayed between base station 222 and target device 1540. Accordingly, UPF 230 may send the traffic flows of PDU set type 1 and PDU set type 1 to target device 1540 via one or more SDFs.

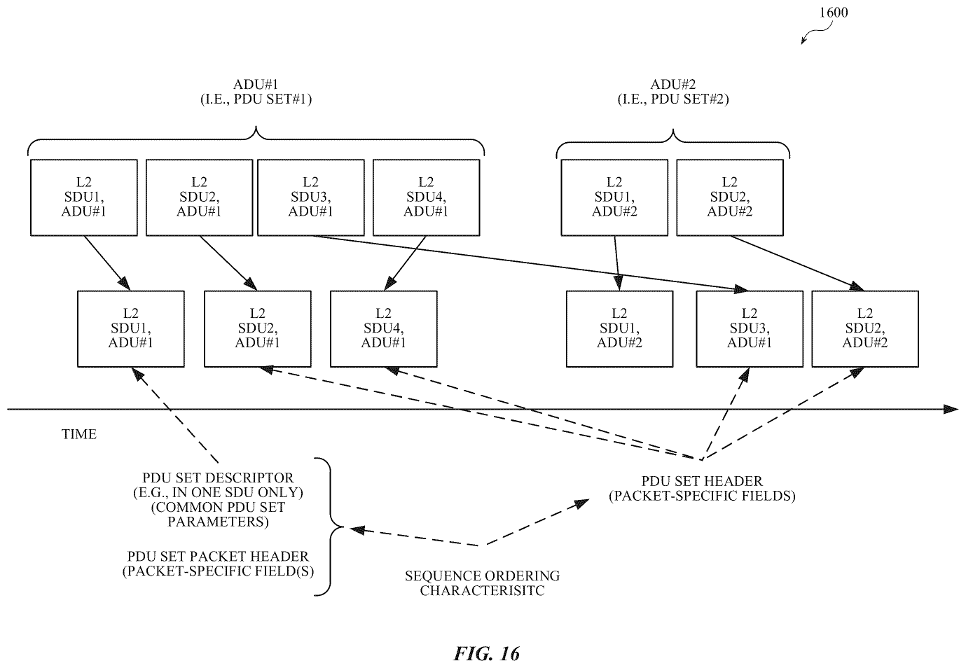

FIG. 16 is a diagram of an example of PDU sets sent and received using a packet data unit (PDU) set descriptor and/or a PDU set header according to one or more implementations described herein. As shown, example 1600 includes two PDU sets (PDU set #1 and PDU set #2). P A PDU set may consist of application data units (ADUs) or PDUs at an upper layer, such as an application layer. PDU set #1 includes L2 SDU1 through L2 SDU4, and PDU set #2 includes L2SDU1 and L2 SDU 2.

As shown, the L2 SDUs of PDU set #1 and PDU set #2 may be transmitted and received at a lower layer (e.g., a PDCP layer) out of order, with L2 SDU3 of PDU set #1 arriving between L2 SDU1 and L2 SDU2 of PDU set #2. Transmission and reception may occur via the Uu interface, the F1 interface, or the N3 interface.

However, properly delivery of the SDUs to upper layers may be ensured based on a sequence ordering characteristic or delivery mode indication included in a packet header such as a PDU set descriptor or a PDU set header. For example, a PDU set descriptor and/or PDU set header may be used. For example, each PDU set (e.g., PDU set #1 and PDU set #2) may include one SDU (e.g., L2 SDU 1 of PDU set #1 and PDU set #2) with a packet set descriptor. The packet set descriptor may indicate common PDU set parameters. Common PDU set parameters may include parameter information applicable to all packets (PDUs or SDUs) in a PDU set. The same SDU (e.g., L2 SDU 1 of PDU set #1 and PDU set #2) may also or alternatively include a PDU set packet header with one or more packet-specific fields. The packet-specific fields may include parameter information associated with packets (PDUs or SDUs) of a PDU set. The other SDUs of each PDU set (e.g., SDU2, 3, and 4 or PDU set #1 and SDU2 of PDU set #2) may include a PDU set packet header with packet-specific fields corresponding a PDU set descriptor of the PDU set. This information may enable UE 110, base station 222, or UPF 230 to determine a deliver mode for each PDU set and deliver (during transmission or reception) corresponding data units to other layers accordingly. In some implementations, the PDU set descriptor may be sent over a control plane or a user plane (either as semi-static information or as dynamic information). Additionally, a PDU set header may be sent over a user plane only (as dynamic information) in a new/extended packet header that is associated with each packet of a PDU set.

Examples herein can include subject matter such as a method, means for performing acts or blocks of the method, at least one machine-readable medium including executable instructions that, when performed by a machine (e.g., a processor (e.g., processor, etc.) with memory, an application-specific integrated circuit (ASIC), a field programmable gate array (FPGA), or the like) cause the machine to perform acts of the method or of an apparatus or system for concurrent communication using multiple communication technologies according to implementations and examples described.

In example 1, which may also include one or more of the examples described herein, a device may comprise a memory and one or more processors configured to, when executing instructions stored in the memory, cause the device to: communicate, via a wireless communication network, information as in-order traffic; and communicate, via the wireless communication network, information using out-of-order traffic, wherein the out-of-order traffic comprising selective out-of-order delivery (OOD) or per-packet OOD delivery.

In example 2, which may also include one or more of the examples described herein, the out-of-order traffic comprises at least one of: one or more packet data units (PDUs), one or more PDU set types, one or more packet data convergence protocol (PDCP) service data units (SDUs), one or more service data adaptation protocol (SDAP) service data units (SDUs), one or more traffic flows, one or more service data flows (SDFs), or one or more quality of service (QoS) flows.

In example 3, which may also include one or more of the examples described herein, the in-order traffic comprises a first type of PDU sets or QoS flows, and the out-of-order traffic comprises a second type of PDU sets or QoS flows.

In example 4, which may also include one or more of the examples described herein, the in-order traffic comprises a primary QoS flow and the out-of-order traffic comprises a secondary QoS flow.

In example 5, which may also include one or more of the examples described herein, the in-order traffic and the out-of-order traffic correspond to the same quality flow identifier (QFI).

In example 6, which may also include one or more of the examples described herein, headers of packets of the out-of-order traffic comprise an out-of-order flag.

In example 7, which may also include one or more of the examples described herein, packets of the out-of-order traffic are configured to be determined for OOD by deep packet inspection (DPI).

In example 8, which may also include one or more of the examples described herein, the in-order traffic corresponds to a first QFI and the out-of-order traffic correspond to a second QFI being different than the first QFI.

In example 9, which may also include one or more of the examples described herein, the in-order traffic is configured to be identified by a packet data convergence protocol (PDCP) receiver based on the first QFI and the out-order traffic is configured to be identified by the PDCP receiver based on the second QFI.

In example 10, which may also include one or more of the examples described herein, upper layers of the device are configured to provide lower layers with an indication of which traffic is configured for OOD.

In example 11, which may also include one or more of the examples described herein, designation of the in-order traffic and the out-of-order traffic is based on a configuration received from a base station or a core network.

In example 12, which may also include one or more of the examples described herein, designation of the in-order traffic and the out-of-order traffic is based on a configuration received from a control plane of the wireless communication network.

In example 13, which may also include one or more of the examples described herein, the out-of-order traffic is indicated based on at least one of: a property of a corresponding QoS flow, a property of a corresponding PDU set or a PDU set type, a property of a corresponding traffic flow or a SDF, a property of a packet header on a per-packet basis, or a property of a packet header field of an upper layer payload.

In example 14, which may also include one or more of the examples described herein, the device comprises one of: a user equipment (UE), a base station, or a function of a core network.

In example 15, which may also include one or more of the examples described herein, a wherein radio resource control (RRC) is used to configure a packet data convergence protocol (PDCP) and a data radio bearer (DRB) for the selective OOD or the per-packet OOD.

In example 16, which may also include one or more of the examples described herein, an uplink (UL) PDU session information is configured to enable a user plane function (UPF) to receive control information elements (IEs) associated with a transfer of packets over an N3 interface, and downlink (DL) PDU session information is configured to enable a base station to receive control IEs associated with a transfer of packets over an N3 interface.

In example 17, which may also include one or more of the examples described herein, an OOD is configured to be indicated in each of the UL PDU session information on a per-packet basis using 1-bit field.

In example 18, which may also include one or more of the examples described herein, the out-of-order traffic is indicated using a quality of service (QOS) flow information element (IE) via an N2 interface.

In example 19, which may also include one or more of the examples described herein, a method, performed by a device, the method comprising: communicating, via a wireless communication network, information as in-order traffic; and communicating, via the wireless communication network, information using out-of-order traffic, wherein the out-of-order traffic comprising selective out-of-order delivery (OOD) or per-packet OOD delivery.

Examples herein can include subject matter such as a method, means for performing

The above description of illustrated examples, implementations, aspects, etc., of the subject disclosure, including what is described in the Abstract, is not intended to be exhaustive or to limit the disclosed aspects to the precise forms disclosed. While specific examples, implementations, aspects, etc., are described herein for illustrative purposes, various modifications are possible that are considered within the scope of such examples, implementations, aspects, etc., as those skilled in the relevant art can recognize.

In this regard, while the disclosed subject matter has been described in connection with various examples, implementations, aspects, etc., and corresponding Figures, where applicable, it is to be understood that other similar aspects can be used or modifications and additions can be made to the disclosed subject matter for performing the same, similar, alternative, or substitute function of the subject matter without deviating therefrom. Therefore, the disclosed subject matter should not be limited to any single example, implementation, or aspect described herein, but rather should be construed in breadth and scope in accordance with the appended claims below.

In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations. In addition, while a particular feature may have been disclosed with respect to only one of several implementations, such feature may be combined with one or more other features of the other implementations as may be desired and advantageous for any given application.

As used herein, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items can be distinct, or they can be the same, although in some situations the context may indicate that they are distinct or that they are the same.

It is well understood that the use of personally identifiable information should follow privacy policies and practices that are generally recognized as meeting or exceeding industry or governmental requirements for maintaining the privacy of users. In particular, personally identifiable information data should be managed and handled to minimize risks of unintentional or unauthorized access or use, and the nature of authorized use should be clearly indicated to users.

What is claimed is:

1. A baseband processor, comprising:
one or more processors configured to:
provide User Equipment (UE) capability information including an indication of whether the UE is capable of communicating information as out-of-order traffic, wherein the out-of-order traffic comprises selective out-of-order delivery (OOD) or per-packet OOD;
receive an OOD configuration; and
communicate information as in-order traffic and out-of-order traffic based on the OOD configuration.

2. The baseband processor of claim 1, wherein the out-of-order traffic comprises at least one of:
one or more packet data units (PDUs),
one or more PDU set types,
one or more packet data convergence protocol (PDCP) service data units (SDUs),
one or more service data adaptation protocol (SDAP) service data units (SDUs),
one or more traffic flows,
one or more service data flows (SDFs), or
one or more quality of service (QOS) flows.

3. The baseband processor of claim 1, wherein the in-order traffic comprises a first type of PDU sets or QoS flows, and the out-of-order traffic comprises a second type of PDU sets or QoS flows.

4. The baseband processor of claim 1, wherein the in-order traffic comprises a primary QoS flow and the out-of-order traffic comprises a secondary QoS flow.

5. The baseband processor of claim 1, wherein the in-order traffic and the out-of-order traffic correspond to the same quality flow identifier (QFI).

6. The baseband processor of claim 5, wherein headers of packets of the out-of-order traffic comprise an out-of-order flag.

7. The baseband processor of claim 5, wherein the one or more processors are further configured to identify a packet of the out-of-order traffic by deep packet inspection (DPI).

8. The baseband processor of claim 1, wherein the in-order traffic corresponds to a first QFI and the out-of-order traffic correspond to a second QFI being different than the first QFI.

9. The baseband processor of claim 8, wherein the in-order traffic is configured to be identified by a packet data convergence protocol (PDCP) receiver based on the first QFI and the out-of-order traffic is configured to be identified by the PDCP receiver based on the second QFI.

10. The baseband processor of claim 1, wherein the one or more processors are further configured to:
using one or more upper layers of the UE, provide one or more lower layers of the UE with an indication of which traffic is configured for OOD.

11. The baseband processor of claim 1, wherein the one or more processors are further configured to identify information as in-order traffic or out-of-order traffic based on the OOD configuration.

12. The baseband processor of claim 1, wherein the out-of-order traffic is indicated based on at least one of:
a property of a corresponding QoS flow,
a property of a corresponding PDU set or a PDU set type,
a property of a corresponding traffic flow or a SDF,
a property of a packet header on a per-packet basis, or
a property of a packet header field of an upper layer payload.

13. The baseband processor of claim 1, wherein the one or more processors are further configured to:
receive a radio resource control (RRC) message to configure a packet data convergence protocol (PDCP) and a data radio bearer (DRB) for the selective OOD or the per-packet OOD.

14. A method for a base station, comprising:
receiving User Equipment (UE) capability information including an indication of whether the UE is capable of communicating information as out-of-order traffic, wherein the out-of-order traffic comprises selective out-of-order delivery (OOD) or per-packet OOD;
transmitting an OOD configuration to the UE based on the UE capability information;
communicating information as in-order traffic and out-of-order traffic with the UE based on the OOD configuration.

15. The method of claim 14, further comprising:
configuring, via the OOD configuration, selective OOD or per-packet OOD based on the UE capability information.

16. The method of claim 14, further comprising:
transmitting a radio resource control (RRC) message to the UE to configure a packet data convergence protocol (PDCP) and a data radio bearer (DRB) for the selective OOD or the per-packet OOD.

17. The method of claim 14, wherein an uplink (UL) PDU session information is configured to enable a user plane function (UPF) to receive control information elements (IEs) associated with a transfer of packets over an N3 interface, and downlink (DL) PDU session information is configured to enable the base station to receive control IEs associated with a transfer of packets over an N3 interface.

18. The method of claim 14, wherein the out-of-order traffic is indicated using a quality of service (QOS) flow information element (IE) via an N2 interface.

19. The method of claim 14, wherein an OOD is configured to be indicated in UL PDU session information on a per-packet basis using a 1-bit field.

20. A User Equipment (UE), comprising:
a memory;
radio front end circuitry; and
processor circuitry, coupled to the radio front end circuitry and the memory, the processor circuitry configured to execute instructions stored in the memory to cause the UE to:
transmit User Equipment (UE) capability information including an indication of whether the UE is capable of communicating information as out-of-order traffic, wherein the out-of-order traffic comprises selective out-of-order delivery (OOD) or per-packet OOD;
receive an OOD configuration; and
communicate information as in-order traffic and out-of-order traffic based on the OOD configuration.
